(19) United States
(12) Patent Application Publication
(10) Pub. No.: US 2025/0284182 A1
(43) Pub. Date: Sep. 11, 2025

(54) ROTARY OPERATING DEVICE AND ELECTRONIC DEVICE

(71) Applicant: CANON KABUSHIKI KAISHA, Tokyo (JP)

(72) Inventor: SAWAKO ITO, Tokyo (JP)

(21) Appl. No.: 19/063,795

(22) Filed: Feb. 26, 2025

(30) Foreign Application Priority Data
Mar. 6, 2024 (JP) 2024-034149

(51) Int. Cl. G03B 17/18

(52) U.S. Cl. CPC G03B 17/18

(57) ABSTRACT

A rotary operating device includes a rotary operating member 20 that can rotate around a rotation axis, a reflecting plate 70 that can rotate integrally with the rotary operating member, and a detection unit 95 that detects reflected light from the reflecting plate 70. The reflecting plate 70 has a plurality of patterns as a detection target portion. A first pattern 70a1 is a circular portion that switches between a bright portion and a dark portion every 180 degrees around the rotation axis. A second pattern 70a2 is a circular portion that switches between a bright portion and a dark portion every 90 degrees around the rotation axis. An angle at which the first pattern 70a1 switches between the bright portion and the dark portion coincides with the angle at which the second pattern 70a2 switches between the bright portion and the dark portion.

### BACKGROUND OF THE INVENTION

### Field of the Invention

This invention relates to a rotary operating device, such as a dial device, and an electronic device equipped with a rotary operating device.

### Description of the Related Art

Dial devices with which electronic devices such as digital cameras, video cameras, and portable information terminals are equipped are used for changing operating modes and various settings. For example, a dial device has a conductive pattern fixed to the electronic device main body to detect the rotation phase, and consists of a plate spring-like phase contact piece that slides against the conductive pattern and is fixed to a rotatable dial.

In addition, a dial device has a plurality of grooves arranged side by side in the direction of rotation and a sphere that engages with each groove, and is configured to engage and disengage the sphere and grooves as the dial is rotated, generating a clicking sensation in the rotary operation of the dial.

In a configuration for using sliding between the phase contact strip and the conductive pattern, in a case where wear particles are generated, they may cause unintended shorts between signals, resulting in false detection. Japanese Patent Laid-Open No. 2022-191824 discloses a rotary switch for detecting the phase of the rotary operating member by photo-interrupters and slits in a non-contact manner.

The rotary switch has a detection target portion formed integrally with the operating axis, and is configured to detect the presence or absence of a slit formed on a rotary position detectable body or a status detectable body by a plurality of multiple photo-interrupters. Any one of 2n states, which is the number of combinations of ON/OFF of the detection outputs of the n photo-interrupters, is specified.

Incidentally, the rotation angle (resolution) of the dial device is set at a desired number of phases, and the shape of the conductive pattern differs for each phase number. Therefore, in a case where a different number of phases is to be set, the shape of the conductive pattern needs to be changed each time.

In addition, in the conventional technology disclosed in Japanese Patent Laid-Open No. 2022-191824, the number of inner slits is provided according to the desired state, which may cause the device to become larger. In addition, phase detection is performed by the detection signals at the rotary position detectable body or the status detectable body, and the presence or absence of a slit in the status detectable body is detected.

However, the position of the slit is fixed, and the combination of the detection output of the photo-interrupter pertaining to the status detectable body is limited. Therefore, the rotary operating member is configured for reciprocating rotation and cannot be rotated all the way around.

### SUMMARY OF THE INVENTION

The rotary operation device of the embodiment of the present invention includes a rotary operating member that can rotate around a rotary axis, a reflective member that can rotate together with the rotary operating member, and a detection unit configured to detect reflected light from the reflective member, in which the reflective member is provided with a plurality of detection target portions each having a bright portion and a dark portion. A first detection target portion of the plurality of detection target portions is a portion formed in an annular shape in which a bright portion and a dark portion switch every 180 degrees around the rotation axis, A second detection target portion of the plurality of detection target portions is a portion formed in an annular shape in which a bright portion and a dark portion switch every 90 degrees around the rotation axis. An angle at which the bright portion and dark portion switch at the first detection target portion is the same as the angle at which the bright portion and dark portion switch at the second detection target portion.

Further features of the present invention will become apparent from the following description of embodiments with reference to the attached drawings.

### BRIEF DESCRIPTION OF THE DRAWINGS

FIG. 1 is a perspective view illustrating a main body of a camera of an embodiment.

FIGS. 2A and 2B are exploded perspective views illustrating a configuration of a rotary operating device according to the embodiment.

FIG. 3 is a cross-sectional view illustrating the configuration of the rotary operating device according to the embodiment.

FIGS. 4A to 4C are diagrams for illustrating an arrangement of a reflecting plate and a detection unit in the embodiment.

FIGS. 5A-1 to 5E-2 are diagrams for illustrating a detection target portion of the reflecting plate and a detection signal for each phase number.

FIGS. 6A to 6G are diagrams for illustrating an example of a rotary operating member having six phases.

FIGS. 7A and 7B are perspective views illustrating another example of a retention mechanism that generates a clicking sensation.

FIG. 8 is a perspective view illustrating still another example of a retention mechanism that generates a clicking sensation.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

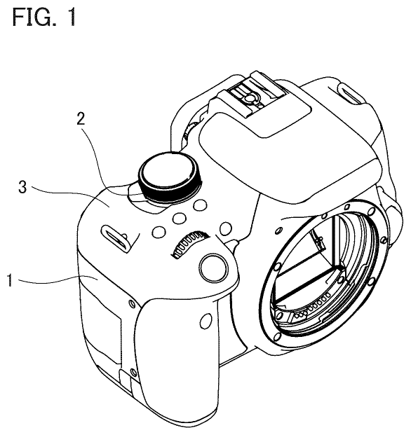

In the embodiment, an imaging device will be described as an example of an electronic device equipped with a rotary operating device. Referring to FIGS. 1 to 3, the configuration of the rotary operation module for the embodiment is described.

FIG. 1 is a perspective view illustrating a main body of a digital camera (hereinafter, simply referred to as the “camera”) 1. For example, the camera 1 is a digital single-lens reflex camera. The main body of the camera 1 is equipped with a mode dial unit 2 and an exterior cover 3. In the following description, the side of the main body of the camera 1 on which the exterior cover 3 is provided is defined as the upper side.

The mode dial unit 2 is provided on the top surface of the main body of the camera 1. The mode dial unit 2 is a rotary operating device used by the user to operate and set various imaging conditions.

For example, the user can select the desired imaging mode by rotating the mode dial unit 2 in a clockwise or counterclockwise direction. Imaging modes include a shutter speed priority mode (Tv mode), an aperture priority mode (Av mode), and a movie mode.

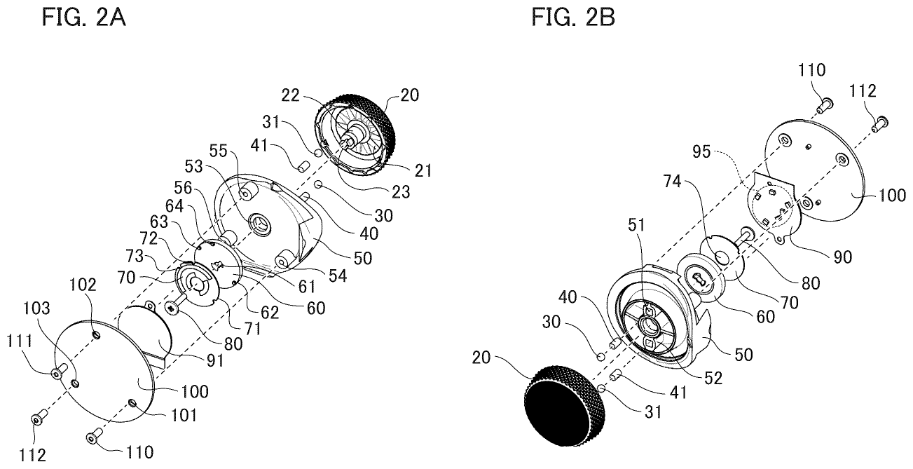

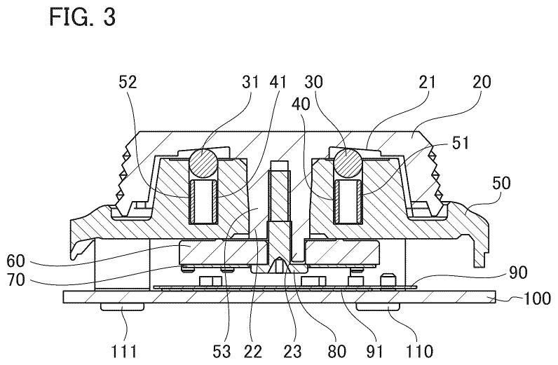

Referring to FIGS. 2 and 3, the rotary operation of the mode dial unit 2 will be described. FIG. 2A is an exploded perspective view of the mode dial unit 2 as viewed obliquely from below. FIG. 2B is an exploded perspective view of the mode dial unit 2 as viewed obliquely from below. FIG. 3 is a cross-sectional view of the mode dial unit 2. The rotary operating member 20 of the mode dial unit 2 is a member that is rotated by the user and can be rotated 360 degrees. The mode dial unit 2 is equipped with a retention mechanism (hereinafter, referred to as “click mechanism”) to generate a clicking operation force (click force) in accordance with the rotary operation of the rotary operating member 20.

The click mechanism has a sphere, an elastic member, and a groove. Click balls 30 and 31 are arranged in grooves 21 provided inside the rotary operating member 20, and click forces can be generated by biasing the click balls 30 and 31 in the direction of the rotation axis by compression springs 40 and 41.

The compression springs 40 and 41 and the click balls 30 and 31 are assembled into the holes of storage portions 51 and 52 in an exterior member 50. The click mechanism will be described in detail later.

The rotary operating member 20 is rotatably supported by the exterior member 50 with its shaft portion 22 slidably fitted into a hole portion 53 of the exterior member 50. A convex 23 on a shaft 22 is fixed in rotation phase to the hole 61 on a receiving plate 60 of a reflecting plate 70 and is fastened with screws 80.

The reflecting plate 70 is a reflective member having a bright portion where the reflectance is equal to or greater than a threshold value and a dark portion where the reflectance is less than the threshold value. The reflecting plate 70 is positioned by convexes 62, 63, and 64 on the receiving plate 60 and concavities 71, 72, and 73 on the reflecting plate 70, and is fixed by adhesion using double-sided adhesive tape, or the like, not illustrated. A fixing member 100 is fixed to the exterior member 50 with fastening members 110, 111, and 112.

With the above configuration, the rotary operating member 20, the receiving plate 60, and the reflecting plate 70 are rotatable together, but their positions in the direction of the rotation axis are fixed. In Present Embodiment, the storage portions 51 and 52 are integrally formed with the exterior member 50, but there is no limitation to this configuration; the storage portions 51 and 52 formed separately may be fixed to the exterior member 50.

In addition, the configuration is not limited to the fixing member 100 being directly fixed to the exterior member 50, and the fixing member 100 may also be indirectly fixed to the exterior member 50 via another member. Since the storage portions 51 and 52 of Present Embodiment are part of the exterior member 50, the outside of the exterior member 50 including the storage portions 51 and 52 is defined as the “exterior side”, and the inside of the exterior member 50 is defined as the “interior side”.

Next, the click mechanism of the mode dial unit 2 will be described with reference to FIGS. 2 and 3. The groove 21 of the rotary operating member 20 faces the click balls 30 and 31 on the exterior side. In the groove 21, wavy concave and convex portions are formed at regular intervals.

Specifically, the wavy concave and convex portions are alternating valleys and peaks extending radially from the axis center. The number of phases of the rotary operating member 20 is denoted as “n”. The number of valleys and peaks extending radially from the axis center is n, respectively. In other words, the phase to be rotated by to transition to one mode is “360/n” degrees.

The pair of click balls 30 and 31 are positioned in phase with respect to the wavy concave and convex portions of the groove 21 at the same timing in the valley, and are always biased upward by the compression springs 40 and 41 to the rotary operating member 20 against the wavy concave and convex portions.

Therefore, the rotary operating member 20 stops at the position where the click balls 30 and 31 fit into the valley of the wavy concave and convex portions. When the user operates the rotary operating member 20 to rotate it by an angle corresponding to one unit position, the click balls 30 and 31 come over the peaks of the wavy concave and convex portions and fit into the adjacent valley.

At this time, a click force is generated in the rotary operating member 20, providing the user with a clicking sensation corresponding to one click. Therefore, the user can rotate the rotary operating member 20 accurately by the intended number of clicks.

Next, a phase detection unit will be described with reference to FIGS. 2 to 6. In the following, flexible printed substrates (see FIGS. 2 and 3:90) are simply referred to as the “substrate”. A substrate 90 is fixed to the fixing member 100 with an adhesive material 91 such as double-sided adhesive tape, and is electrically connected to the control circuit of the camera 1 (not illustrated).

Holes 101, 102, and 103 in the fixing member 100 correspond to screw holes 54, 55, and 56 which are provided in the exterior member 50, respectively, through which the fastening members 110, 111, and 112 are inserted to fasten the fixing member 100 to the exterior member 50.

With the above configuration, the position of the substrate 90 in the rotation axis direction is fixed. A predetermined number of detection units 95 are mounted on the surface of the substrate 90. The detection unit 95 is an electronic component, such as a photo reflector, for example.

The photo reflecting plate is a non-contact sensor and incorporates a light emitting source and a light receiving sensor. Light emitted from the light emitting source is reflected by the reflecting plate 70, and the intensity of the reflected light is detected by the light receiving sensor, thereby measuring the reflectance of the reflecting plate 70. Various sensors capable of measuring the reflection intensity of the reflecting plate can be used, without being limited to photo reflecting plates.

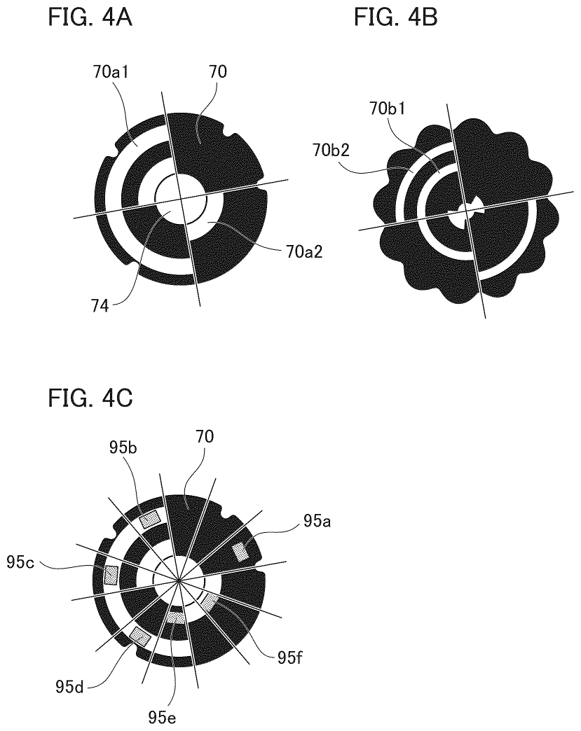

Referring to FIG. 4, the number of phases of the rotary operating member 20 and the arrangement of the plurality of detection units 95 will be described. FIG. 4A is a diagram illustrating a first shape pattern related to the reflective member. A hole 74 is formed in the center of rotation of the reflecting plate 70, and the screws 80 are inserted into the hole 74 to fasten it to the receiving plate 60 and the rotary operating member 20. When viewed from the direction along the rotation axis of the rotary operating member 20, the reflecting plate 70 has a plurality of patterns as detection target portions on its inner and outer circumference. A first pattern 70al on the outer circumference is the detection target portion formed in a circular shape with the bright portion and the dark portion switching every 180 degrees around the rotation axis.

A second pattern 70a2 on the inner circumference is a detection target portion formed in a circular shape with the bright portion and the dark portion switching every 90 degrees around the rotation axis. Both the bright portion and the dark portion of the first pattern 70al and the second pattern 70a2 have a fan shape extending in an arc.

The angle at which the bright portion and the dark portion switch in the first pattern 70al coincides with the angle at which the bright portion and the dark portion switch in the second pattern 70a2.

In the patterns 70al and 70a2 of the reflecting plate 70, the bright portions are portions that reflect the light from the detection unit 95 at a level higher than a predetermined reflectance, and the dark portions are portions that reflect the light from the detection unit 95 at a level lower than the predetermined reflectance.

For example, the bright portion consists of a bare metal plate such as aluminum, and the dark portion consists of a black coating applied to the metal plate. Alternatively, the dark portion consists of black sheet material and the bright portion consists of white printing on the sheet material.

By setting the pattern of the reflecting plate 70 to the above settings, the reflective members can be common in a case where the number of phases of the rotary operating member 20 is 2, 4, 6, 8, or 12. In the example in FIG. 4A, the first pattern 70al is considered to be the outer circumference, but this is not limited thereto.

FIG. 4B is a diagram illustrating a second shape pattern regarding the reflective member. In this example, a first pattern 70b1, which switches between the bright portion and the dark portion every 180 degrees, is on the inner periphery side, and a second pattern 70b2, which switches between the bright portion and the dark portion every 90 degrees, is on the outer periphery side.

However, since the number of detection units 95 arranged on the inner periphery side can be reduced in the example of FIG. 4A, it is possible to achieve a greater miniaturization compared to the example of FIG. 4B.

Referring to FIG. 4C, the arrangement of the plurality of detection units 95a to 95f with respect to the reflecting plate 70 will be described. The first to fourth detection units 95a to 95d are installed on the outer periphery side of the substrate 90, opposite the first pattern 70al, and are electrically connected to the substrate 90. The arrangement of the detection units 95a to 95d is as follows.
The first detection unit 95a is installed in one of a plurality of locations that are divided into 12 areas based on the center of the reflecting plate 70.
The second detection unit 95b is installed at a position rotated 90 degrees counterclockwise in FIG. 4C from the first detection unit 95a.
The third detection unit 95c is installed at a position rotated 60 degrees in the opposite direction (counterclockwise) to the first detection unit 95a with respect to the second detection unit 95b.
The fourth detection unit 95d is installed at a position rotated 60 degrees in the opposite direction (counterclockwise) from the second detection unit 95b with respect to the third detection unit 95c.

Although the arrangement of the plurality of detection units in the counterclockwise direction is illustrated in FIG. 4C, it is not limited to this example. For each detection unit, the clockwise direction may be used as the reference direction.

The fifth detection unit 95e and the sixth detection unit 95f are arranged opposite the second pattern 70a2. The fifth detection unit 95e and the sixth detection unit 95f are installed at an angular distance of 60 degrees from the center of the reflecting plate 70 and at least 30 degrees from the first detection unit 95a.

The advantage of the above arrangement of the patterns 70al and 70a2 of the reflecting plate 70 and the plurality of detection units 95 is that the same shape can be used in a case where the number of phases of the rotary operating member 20 is 2, 4, 6, 8, or 12. It is possible to achieve commonality of all other components in the rotary operating device, except for the rotary operating member 20.

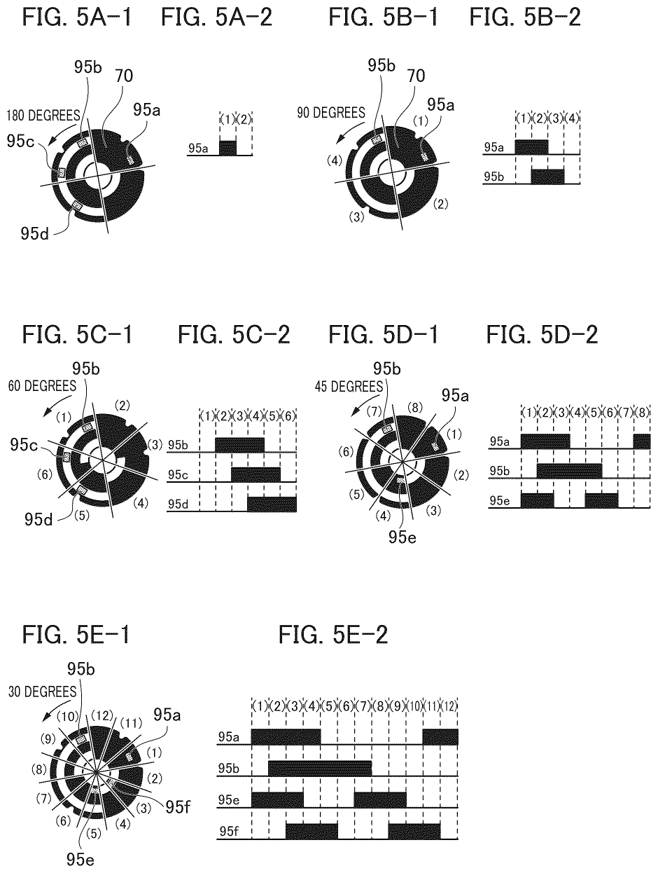

Referring to FIG. 5, the arrangement of the reflecting plate 70 and the detection unit 95 and the detection signal by the detection unit 95 at each phase number are described. In FIG. 5, for convenience of explanation, the range for each angle of 360 degrees divided by the number of each phase is denoted as areas (1) to (12). The black range in the area corresponds to the dark portion in the pattern of the reflecting plate 70.

FIG. 5A-1 illustrates the arrangement of the reflecting plate 70 and the detection unit 95 in a case where the number of phases of the rotary operating member 20 is 2. FIG. 5A-2 illustrates signals of the bright portion and the dark portions detected by the detection unit 95a in a case where the rotary operating member 20 rotates in the direction of the arrow in FIG. 5A-1.

The area (1) corresponds to the state in FIG. 5A-1. In a case where the number of phases of the rotary operating member 20 is 2, position detection should be performed by any one of the first to fourth detection units 95a to 95d.

FIG. 5A-2 illustrates the signal detected by the detection unit 95a in a case where the rotary operating member 20 is in the predetermined position. In the state illustrated in FIG. 5A-1, the detection unit 95a detects the dark portion of the pattern, but when the rotary operating member 20 is rotated 180 degrees in the direction of the arrow, the bright portion of the pattern is detected. In a case where any of the detection units 95b, 95c, or 95d is selected, the relationship between the bright portion and the dark portion is reversed from the above.

FIG. 5B-1 illustrates the arrangement of the reflecting plate 70 and the detection unit 95 in a case where the number of phases of the rotary operating member 20 is 4. In FIG. 5B-1, the detection unit 95a detects the dark portions and the detection unit 95b detects the bright portions.

FIG. 5B-2 illustrates signals of the bright portion and the dark portion detected by the detection units 95a and 95b in a case where the rotary operating member 20 rotates in the direction of the arrow in FIG. 5B-1. The area (1) corresponds to the state in FIG. 5B-1.

When the reflecting plate 70 is rotated 90 degrees in the direction of the arrow in FIG. 5B-1, the dark portion of the reflecting plate 70 is positioned opposite the detection unit 95b, and both detection units 95a and 95b output a signal of the dark portion as shown in the area (2).

When the reflecting plate 70 is further rotated 90 degrees in the direction of the arrow from this state, the bright portion of the reflecting plate 70 is positioned opposite the detection unit 95a and the dark portion opposite the detection unit 95b. As shown in the area (3), the detection unit 95a outputs a signal of the bright portion and the detection unit 95b outputs a signal of the dark portion.

When the reflecting plate 70 is further rotated 90 degrees in the direction of the arrow from this state, the bright portion of the reflecting plate 70 is positioned opposite the detection units 95a and 95b. As shown in the area (4), both detection units 95a and 95b will be in a state where they both output a signal of the bright portion.

As described above, phase detection using two detection units 95a and 95b allows detection of four different states in the areas (1) to (4) by combining the bright portion and the dark portion.

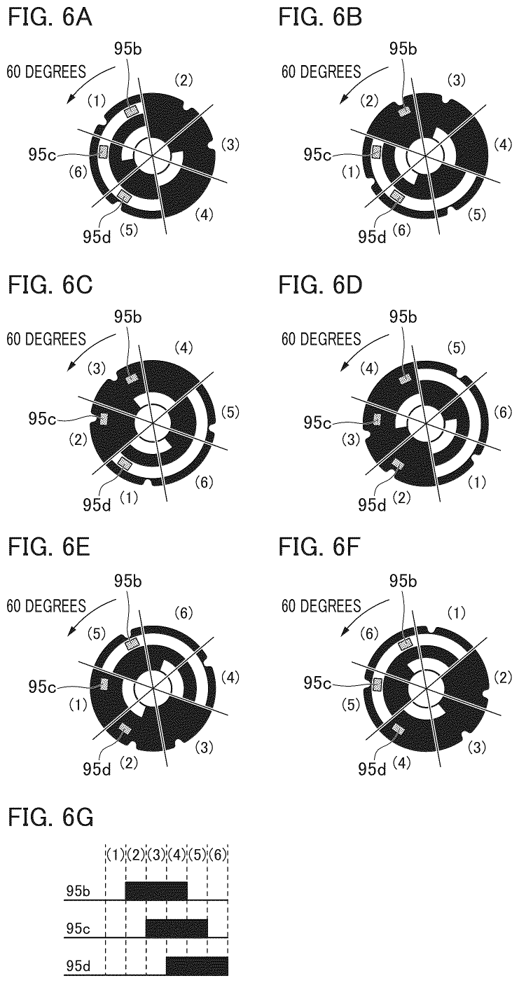

FIG. 5C-1 illustrates the arrangement of the reflecting plate 70 and the detection unit 95 in a case where the number of phases of the rotary operating member 20 is 6. FIG. 5C-2 illustrates the signals of the bright portion and the dark portion detected by the detection units 95b, 95c, and 95d in a case where the rotary operating member 20 rotates in the direction of the arrow in FIG. 5C-1. The area (1) corresponds to the state in FIG. 5C-1. This will be described in detail with reference to FIG. 6.

FIG. 6 is a detailed diagram of each phase when the reflecting plate 70 illustrated in FIG. 5C-1 rotates. FIG. 6A corresponds to FIG. 5C-1, and FIGS. 6B-6F illustrate the reflecting plate 70 rotating counterclockwise every 60 degrees, respectively. FIG. 6G corresponds to FIG. 5C-2.

FIG. 6A illustrates a state where the all of the detection units 95b, 95c, and 95d output a signal of the bright portion (see FIG. 6G: the area (1)). From this state, the reflecting plate 70 rotates 60 degrees in the direction of the arrow to the state illustrated in FIG. 6B.

The dark portion of the reflecting plate 70 is positioned opposite the detection unit 95b. As shown in the area (2) of FIG. 6G, the detection unit 95b outputs the signal of the dark portion, and the detection units 95c and 95d both output a signal of the bright portion.

If the reflecting plate 70 is rotated further by 60 degrees in the direction of the arrow from the state illustrated in FIG. 6B, it attains the state illustrated in FIG. 6C. The dark portion of the reflecting plate 70 is positioned opposite the detection units 95b and 95c. As shown in the area (3) of FIG. 6G, the detection units 95b and 95c both output a signal of a dark portion, and the detection unit 95d outputs a signal of a bright portion.

If the reflecting plate 70 is rotated further by 60 degrees in the direction of the arrow from the state illustrated in FIG. 6C, it attains the state illustrated in FIG. 6D. The dark portion of the reflecting plate 70 is positioned opposite the detection units 95b, 95c, and 95d. As shown in the area (4) of FIG. 6G, the detection units 95b, 95c, and 95d all output a signal of a dark portion.

If the reflecting plate 70 is rotated further by 60 degrees in the direction of the arrow from the state illustrated in FIG. 6D, it attains the state illustrated in FIG. 6E. The dark portion of the reflecting plate 70 is positioned opposite the detection units 95b and 95c. As shown in the area (5) of FIG. 6G, the detection unit 95b outputs a signal of a bright portion, and the detection units 95c and 95d both output a signal of a dark portion.

If the reflecting plate 70 is rotated further by 60 degrees in the direction of the arrow from the state illustrated in FIG. 6E, it attains the state illustrated in FIG. 6F. The dark portion of the reflecting plate 70 is positioned opposite the detection unit 95d. As shown in the area (6) of FIG. 6G, the detection units 95b and 95c both output a signal of a bright portion, and the detection unit 95d outputs a signal of a dark portion.

As described above, phase detection using three detection units 95b, 95c, and 95d allows detection of six different states in the areas (1) to (6) by combining the bright portion and the dark portion.

FIG. 5D-1 illustrates the arrangement of the reflecting plate 70 and the detection unit 95 in a case where the number of phases of the rotary operating member 20 is 8. FIG. 5D-1 illustrates the state where the detection units 95a and 95e output a signal of a dark portion and the detection unit 95b outputs a signal of a bright portion.

FIG. 5D-2 illustrates the signals of the bright portion and the dark portion detected by the detection units 95a, 95b, and 95e in a case where the rotary operating member 20 rotates in the direction of the arrow in FIG. 5D-1. The area (1) corresponds to the state in FIG. 5D-1.

The output state of each detection unit is listed below in a case where the reflecting plate 70 rotates by 45 degrees in the direction of the arrow (counterclockwise) with the state in FIG. 5D-1 as a reference.
At the time of rotation of 45 degrees: The dark portion of the reflecting plate 70 is positioned opposite the detection units 95a, 95b, and 95e, and all three detection units output a signal of the dark portion (see the area (2) in FIG. 5D-2).
At the time of rotation of 90 degrees: The dark portion of the reflecting plate 70 is positioned opposite the detection units 95a and 95b, and the detection units 95a and 95b output the signal of the dark portion and the detection unit 95e outputs the signal of the bright portion (see the area (3) in FIG. 5D-2).
At the time of rotation of 135 degrees: The dark portion of the reflecting plate 70 is positioned opposite the detection unit 95b. The detection unit 95b outputs a signal of a dark portion, and the detection units 95a and 95e both output a signal of the bright portion (see the area (4) in FIG. 5D-2).
At the time of rotation of 180 degrees: The dark portion of the reflecting plate 70 is positioned opposite the detection units 95b and 95e. The detection units 95b and 95e both output a signal of a dark portion and the detection unit 95a outputs a signal of the bright portion (see the area (5) in FIG. 5D-2).
At the time of rotation of 225 degrees: The dark portion of the reflecting plate 70 is positioned opposite the detection unit 95e. The detection unit 95e outputs a signal of a dark portion, and the detection units 95a and 95b both output a signal of a bright portion (see the area (6) in FIG. 5D-2).
At the time of rotation of 270 degrees: The bright portion of the reflecting plate 70 is positioned opposite the detection units 95a, 95b, and 95e. All three detection units output a signal of a bright portion (see the area (7) in FIG. 5D-2).
At the time of rotation of 315 degrees: The dark portion of the reflecting plate 70 is positioned opposite the detection unit 95a. The detection unit 95a outputs a signal of a dark portion, and the detection units 95b and 95e both output a signal of a bright portion (see the area (8) in FIG. 5D-2).

As described above, phase detection using three detection units 95a, 95b, and 95e allows detection of eight different states in the areas (1) to (8) by combining the bright portion and the dark portion.

FIG. 5E-1 illustrates the arrangement of the reflecting plate 70 and the detection unit 95 in a case where the number of phases of the rotary operating member 20 is 12. FIG. 5E-1 illustrates the state where the detection units 95a and 95e output a signal of a dark portion and the detection units 95b and 95f output a signal of a bright portion.

FIG. 5E-2 illustrates signals of a bright portion and a dark portion detected by the detection units 95a, 95b, 95e, and 95f in a case where the rotary operating member 20 rotates in the direction of the arrow in FIG. 5E-1.

The area (1) corresponds to the state in FIG. 5E-1. The output state of each detection unit is listed below in a case where the reflecting plate 70 rotates by 30 degrees in the direction of the arrow (counterclockwise) with the state in FIG. 5E-1 as a reference.
At the time of rotation of 30 degrees: The dark portion of the reflecting plate 70 is positioned opposite the detection units 95a, 95b, and 95e. The detection units 95a, 95b, and 95e all output a signal of a dark portion, and the detection unit 95f outputs a signal of a bright portion (see the area (2) in FIG. 5E-2.
At the time of rotation of 60 degrees: The dark portion of the reflecting plate 70 is positioned opposite the detection units 95a, 95b, 95e, and 95f. All four detection units will be in a state where they all output a signal of a dark portion (see the area (3) in FIG. 5E-2.
At the time of rotation of 90 degrees: The dark portion of the reflecting plate 70 is positioned opposite the detection units 95a, 95b, and 95f. The detection units 95a, 95b, and 95f all output a signal of a dark portion, and the detection unit 95e outputs a signal of a bright portion (see the area (4) in FIG. 5E-2).
At the time of rotation of 120 degrees: The dark portion of the reflecting plate 70 is positioned opposite the detection units 95b and 95f. The detection units 95b and 95f both output a signal of a dark portion and the detection units 95a and 95e both output a signal of a bright portion (see the area (5) in FIG. 5E-2).
At the time of rotation of 150 degrees: The dark portion of the reflecting plate 70 is positioned opposite the detection unit 95b. The detection unit 95b outputs a signal of a dark portion, and the detection units 95a, 95e, and 95f all output a signal of a bright portion (see the area (6) in FIG. 5E-2).
At the time of rotation of 180 degrees: The dark portion of the reflecting plate 70 is positioned opposite the detection units 95b and 95e. The detection units 95b and 95e both output a signal of a dark portion and the detection units 95a and 95f both output a signal of a bright portion (see the area (7) in FIG. 5E-2).
At the time of rotation of 210 degrees: The dark portion of the reflecting plate 70 is positioned opposite the detection unit 95e. The detection unit 95e outputs a signal of a dark portion, and the detection units 95a, 95b, and 95f all output a signal of a bright portion (see the area (8) in FIG. 5E-2).
At the time of rotation of 240 degrees: The dark portion of the reflecting plate 70 is positioned opposite the detection units 95e and 95f. The detection units 95e and 95f both output a signal of a dark portion and the detection units 95a and 95b both output a signal of a bright portion (see the area (9) in FIG. 5E-2).
At the time of rotation of 270 degrees: The dark portion of the reflecting plate 70 is positioned opposite the detection unit 95f. The detection unit 95f outputs a signal of a dark portion, and the detection units 95a, 95b, and 95e all output a signal of a bright portion (see the area (10) in FIG. 5E-2).
At the time of rotation of 300 degrees: The dark portion of the reflecting plate 70 is positioned opposite the detection units 95a and 95f. The detection units 95a and 95f both output a signal of a dark portion, and the detection units 95b and 95e both output a signal of a bright portion (see the area (11) in FIG. 5E-2).
At the time of rotation of 330 degrees: The dark portion of the reflecting plate 70 is positioned opposite the detection unit 95a. The detection unit 95a outputs a signal of a dark portion, and the detection units 95b, 95e, and 95f all output a signal of a bright portion (see the area (12) in FIG. 5E-2).

As described above, phase detection using four detection units 95a, 95b, 95e, and 95f allows detection of twelve different states in the areas (1) to (12) by combining the bright portion and the dark portion.

Although FIG. 5 illustrates the arrangement of the detection units and their output signals at each phase number, the number of the detection units 95 mounted on the substrate may be all six, as illustrated in FIG. 4C.

Alternatively, as illustrated in FIGS. 5A-1, 5B-1, 5C-1, 5D-1, and 5E-1, depending on the number of phases, the number of detection units on the board can be reduced and contribute to cost reduction.

Next, a method for aligning the phase between the rotary operating member 20 and the reflecting plate 70 will be described. The rotary operating member 20 has the groove 21 extending radially from the shaft center, and is formed of wavy concave and convex portions with alternating valleys and peaks extending radially from the shaft center at regular intervals.

The apexes of the mountains coincide in rotational phase with the switching position of the bright portion and the dark portion of the first pattern 70al or the second pattern 70a2 of the reflecting plate 70. If the number of phases is expressed as n, the bottom position of the groove 21 corresponds to the position rotated by “180/n” degrees from the apex of the mountain above.

For example, in a case where the number of phases illustrated in FIG. 5E-1 is 12, the click balls 30 and 31 engage the groove 21 every 30 degree phase. At that time, the reflecting plate 70 stays in the position corresponding to one of the areas (1) to (12).

Since the click balls 30 and 31 reliably stop in a state corresponding to any one of the areas (1) to (12), the user can sense the click force, and the detection unit 95 can stably detect a signal.

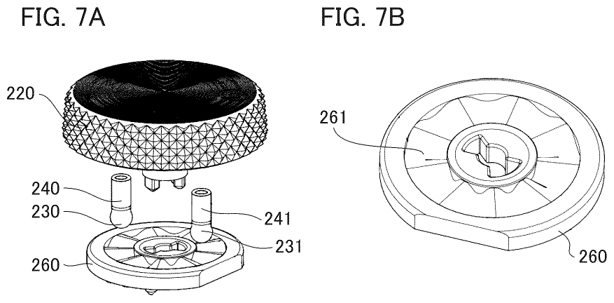

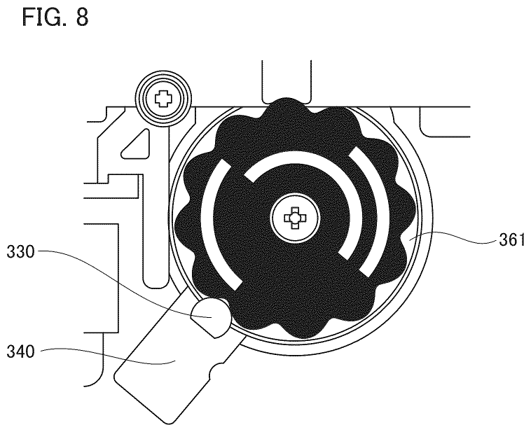

In the above example, a click mechanism using the groove 21 of the rotary operating member 20, the click balls 30 and 31, and the compression springs 40 and 41 is described, but is not limited to this configuration. A modification embodiment is illustrated in FIGS. 7 and 8.

FIG. 7 illustrates an example of a retention mechanism for a rotary operating member as the first modification embodiment. FIG. 7A is an exploded perspective view of the rotary operating member. FIG. 7B is a perspective view of a receiving plate 260 having the groove 261. The difference is that in the example of FIG. 2, the groove 21 is formed on the rotary operating member 20, but in the example of FIG. 7, a groove 261 is formed on the receiving plate 260.

In the first modification embodiment, the click balls 230 and 231 are biased against the grooves 261 by compression springs 240 and 241, thereby holding the rotary operating member 220. In addition, the direction of force of the click balls 230 and 231 is downward in FIG. 7, but it can be upward. For example, the components of the receiving plate 260 may be arranged inside the rotary operating member 220.

Referring to FIG. 8, another example of the retention mechanism for the rotary operating member is shown as a second modification embodiment. FIG. 8 illustrates a bottom view of the mode dial unit 2 as seen from the inside. A groove 361 is formed in a separate component from the rotary operating member, and the click ball 330 is biased by a compression spring 340 to engage with the groove 361.

However, the direction of force of the click ball 330 is radial, and the concave portion and the convex portion in the groove 361 are formed continuously along the circumferential direction. For example, the groove 361 can be formed on reflecting plate 70 illustrated in FIG. 2.

Forming the groove 361 in the reflecting plate 70 reduces the number of components. Similar to the examples in FIG. 2 and FIG. 7, the configuration in FIG. 8 can also be used to maintain the rotation phase of the rotary operating member 20 and improve the operating feel due to the click force. In particular, in a case where the vertical dimension of the rotary operating member is to be reduced, it is desirable to adopt the configuration shown in the second modification embodiment.

According to the above embodiments and modification embodiments, the optical detection method reduces false detection, the number of phases (resolution) can be easily changed, the rotation of the rotary operating member over the entire circumference is possible, and a more compact rotary operating device can be provided.

Although the preferred embodiment of the present invention has been described above, the present invention is not limited to the above embodiment, and various modifications and changes are possible within the scope of the gist of the present invention. The electronic device in which the rotary operating member is mounted is not limited to imaging devices, but can be applied to a wide range of household electrical appliances, measuring instruments, vehicles, or the like.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

This application claims the benefit of priority from Japanese Patent Application No. 2024-034149, filed on Mar. 6, 2024, which is hereby incorporated by reference herein in its entirety.

What is claimed is:

1. A rotary operating device comprising:
a rotary operating member that can rotate around a rotary axis;
a reflective member that can rotate together with the rotary operating member; and
a detection unit configured to detect reflected light from the reflective member, wherein
the reflective member is provided with a plurality of detection target portions each having a bright portion and a dark portion,
a first detection target portion of the plurality of detection target portions is a portion formed in an annular shape in which a bright portion and a dark portion switch every 180 degrees around the rotation axis,
a second detection target portion of the plurality of detection target portions is a portion formed in an annular shape in which a bright portion and a dark portion switch every 90 degrees around the rotation axis, and
an angle at which the bright portion and dark portion switch at the first detection target portion is the same as the angle at which the bright portion and dark portion switch at the second detection target portion.

2. The rotary operating device according to claim 1, wherein the first detection target portion is positioned on an outer circumference of the reflective member and the second detection target portion is positioned on an inner circumference of the reflective member.

3. The rotary operating device according to claim 1, wherein the first detection target portion is positioned on the inner circumference of the reflective member and the second detection target portion is positioned on the outer circumference of the reflective member.

4. The rotary operating device according to claim 1, wherein, the detection unit is configured to oppose the first detection target portion.

5. The rotary operating device according to claim 1, wherein the detection unit includes a first detection unit and a second detection unit both configured to oppose the first detection target portion, wherein
the first and second detection units are installed at intervals of 90 degrees around the rotation axis.

6. The rotary operating device according to claim 1, wherein the detection unit includes a first detection unit to a third detection unit which are configured to oppose the first detection target portion, wherein
the first to third detection units are installed at intervals of 60 degrees around the rotation axis.

7. The rotary operating device according to claim 5, wherein the detection unit includes a third detection unit configured to oppose the second detection target portion.

8. The rotary operating device according to claim 5, wherein the detection unit includes a third detection unit and a fourth detection unit both configured to oppose the second detection target portion, wherein
the third and fourth detection units are installed at intervals of 60 degrees around the rotation axis and at least 30 degrees apart from the first detection unit around the rotation axis.

9. The rotary operating device according to claim 8, wherein the third detection unit is installed on the opposite side of the first detection unit with respect to the position of the fourth detection unit.

10. The rotary operating device according to claim 1, further comprising a retention mechanism for the rotary operating member, wherein the retention mechanism has a sphere, and an elastic member, and an elastic member forces the sphere into a groove provided around the rotary operating member.

11. The rotary operating device according to claim 10, wherein the groove is provided in the rotary operating member.

12. The rotary operating device according to claim 10, wherein the groove is provided on a receiving plate of the reflective member.

13. The rotary operating device according to claim 10, wherein the reflective member has the groove.

14. The rotary operating device according to claim 1, wherein the number of detection units is different depending on the number of phases of the rotary operating member.

15. An electronic device comprising:
the rotary operating device according to claim 1.
